(19) United States
(12) Patent Application Publication
(10) Pub. No.: US 2011/0016477 A1
(43) Pub. Date: Jan. 20, 2011

(54) PRE-CALCULATION AND CACHING OF DEPENDENCIES

(75) Inventors: Greg D. Schechter, Seattle, WA (US); Alan P. Paulin, Kirkland, WA (US); Karthik Subramanyam, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/503,037

(22) Filed: Jul. 14, 2009

(51) Int. Cl. G06F 9/44; G06F 13/00; G06F 15/16

(52) U.S. Cl. 719/330; 719/331; 709/247; 709/203

(57) ABSTRACT

Dependencies among components may be pre-calculated, validated and cached. The cached dependencies may then be used in an execution environment to inject dependencies into the component. In one example, components for a web application are submitted to the operator of the application. Dependencies among the components may be pre-calculated, and the pre-calculated dependencies may be stored in a catalog. When a client accesses the web application, the components may be downloaded to the client along with the catalog. The client may provide a virtual machine or other execution environment under which the components execute. The execution environment may provide a dependency injection feature that connects components together at runtime based on the pre-calculated dependencies in the catalog.

### BACKGROUND

Dependency injection (“DI”) is a computer programming technique in which dependencies between software components are supplied by an external source, rather than by the components themselves. In traditional programming models that use plural components, one component specifies another component to be called by name. That is, a first object contains the code to call a second object, and the first object identifies the second object by name. On the other hand, in a DI programming model components may be written that do not explicitly depend on each other, but rather depend on an abstract specification of functionality.

For example, suppose a programmer is writing a component and wants the component to specify a shape. In a traditional programming model, the programmer includes, in the component, a call to a specific shape function, such as a function named “Cube.” For the programmer's purposes, it might be the case that any shape would do, and the shape to be specified does not have to be a cube. However, due to the limitations of the traditional programming model, the programmer has to identify a particular function to be called. Thus, in this example, the program is bound to the cube shape, not because the programmer specifically wants to use a cube, but only because the traditional programming model does not allow the programmer to express his or her flexibility about what shapes may be used.

Dependency injection provides the ability for the programmer to say, in effect, “call a shape function to be identified later.” A DI system provides mechanisms by which one component (the “importer”) can say, “I want to call a shape function”, and another component (the “exporter”) can say, “I am a shape function.” The DI system also provides mechanisms by which these components can be “wired up” to work together at some time after the components are developed. Thus, in the above example, the importer and exporter components are not explicitly dependent on each other, but instead are dependent on the abstract notion of a shape function. As long as both components operate under the same understanding of what a shape function does, the components can work together. In programming, the functional understanding that is shared between the importer and exporter is often referred to as a “contract.”

One issue that arises in DI is that implementations of DI tend to be heavily dependent on runtime computation to validate the components, and to determine what components to wire to other components. An importing component typically validates the exporting component by determining, at runtime, that the exporting component is loaded, running, and able to provide the functionality that the importing component wants to use. Performing the validation at runtime has various consequences. First, the runtime environment has to contain the code to verify that the exporting component satisfies the contract, which adds complexity to the runtime environment. Additionally, performing the validation at runtime may consume runtime resources, and may also generate errors if the validation fails. When the components are part of a user application, consumption of resources at runtime may lead to a perception that the application is performing poorly, and generating runtime errors may lead to confusion on the part of the user—as well as leading to inability of the user to do anything to correct the situation.

### SUMMARY

In a dependency injection system, dependencies between components may be calculated and validated in advance of their use. When the dependencies have been calculated and validated, the valid dependencies may be stored in a catalog. A copy of the catalog may be provided to environments in which the components will execute, and the environments can allow components to interoperate based on dependencies that the catalog says are valid. In this way, the components do not have to contain code to validate dependencies, and resources do not have to be expended to perform validations at runtime. Additionally, errors can be flagged to the component developer at the time of component upload, rather than causing an end-user error.

For example, a web-based application may provide components to be executed by a client-side engine, such as Java Runtime Environment (JRE), or the MICROSOFT SILVERLIGHT engine. The components may be written for use with a dependency injection system, which connects components to each other at runtime. These components may be provided along with a catalog that describes which combinations of components are legitimate. The catalog may then be used by the client-side engine to determine which components to connect with each other.

By using a pre-calculated catalog to determine which combinations of components are legitimate, certain features can be implemented that would be difficult to implement in a system that performs runtime validation. For example, since the catalog specifies which components may be used with other components, the catalog may be used to implement a form of access control. A pair of importer/exporter components may be combinable in the sense that they satisfy the same contract, but the provider of one of the components may want to limit the set of components with which it will interoperate. So, if components A and B act as the importer and exporter, respectively, for the same contract but the provider of A does not want A to interoperate with B, then this fact may be detected at the time of pre-validation, and no catalog listing A+B as a legitimate combination will be built.

Another example feature that may be implemented is asynchronous contract loading. In typical dependency injection systems, the exporter component has to be loaded before the importer component can validate it. By using a pre-calculated catalog, the validity of an importer/exporter dependency can be established even if the exporter has not been loaded. Since a given component may have many more dependencies than it actually uses to perform a given task, asynchronous contract loading may prevent resources from being wasted to load components that are not actually used.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which components may be analyzed to determine and validate dependencies.

FIG. 2 is a block diagram of an example catalog.

FIG. 3 is a flow diagram of an example process that may be performed to evaluate components for dependencies.

FIG. 4 is a flow diagram of an example process in which a plug-in may be invoked, and in which pre-calculated dependencies may be injected into the plug-in.

FIG. 5 is a block diagram of an example scenario in which dependencies between components may be pre-calculated, and in which the components and pre-calculated dependencies may be used on a client.

FIG. 6 is a block diagram of example components that may be used in connection with implementations of the subject matter described herein.

### DETAILED DESCRIPTION

Many software applications are extensible through the addition and/or replacement of components. In the early days of computer programming, programs were written as monolithic units. Later, it became possible to develop software in components that could be linked together at compile time. Eventually, it became possible to link components together not merely at compile time, but also at runtime. With the ability to link components at runtime, it is possible that component A can use component B, even if component B is unknown to component A at the time that component A is developed.

While there are various ways that components that are unknown to each other at development time can interact at runtime, one model that may be used to support such interaction is dependency injection (“DI”). If component A uses component B to perform some action, then component B is a dependency of component A. In traditional software development, component A's dependencies would be called out by name in component A's code, and thus would be known at development time. With dependency injection system, the dependencies are “injected” into component A at runtime by the environment in which the components execute. In one paradigm, components execute in a “dependency injection container” that forms part of the execution environment, and the container injects the dependencies into the components. In general, a dependency injection system may inject dependencies into the components from any place external to the components.

One issue that arises in dependency injection systems is that they are very dependent on runtime computation resources. Typically, in order to load component A, component A's dependencies are identified, and all of the component that implement the dependencies are loaded. Component A has to validate the components that implement its dependencies, which has several consequences for complexity and performance. First, component A has to contain the code that is used to validate its dependencies, which increases the size and complexity of component A itself. Second, in a typical implementation, in order for component A to validate its dependencies, every component that implements one of the dependencies has to be loaded and running, even though the particular actions that component A is being invoked to perform might not actually use all of these other components. (E.g., it is possible that component A contains code to do various things, but that in a given session, component A is not actually asked to do all of the things that it is able to do.) Third, the computational resources to perform these validation and loading actions take place at runtime in the environment in which component A is executing, which consumes computation resources at a time and place where such resources may be relatively scarce.

The subject matter herein provides a dependency injection system that pre-calculates and caches dependencies. The calculation is performed in an offline environment. The calculation may involve validating dependencies based on such aspects as whether there is an exporter for every contract that some component imports, and whether there are any type mismatches between components that import/export the same contract. The result of the calculation is to generate a catalog that describes the various components and their dependencies. The catalog, and the components themselves, may be delivered to the execution environment. When the functionality of one of the components is requested in the execution environment, the component may be loaded. If the component has dependencies, the existence of components that have been validated to satisfy those dependencies may be established from the catalog. Thus, a component may be run in its execution environment without having to use the resources of the execution environment to validate dependencies, because the dependencies have been pre-validated in a back-end environment. One consequence of this pre-validation of dependencies is that a component can be loaded even if the components on which it depends are not loaded (or are not even present at the execution environment). As noted above, some dependency injection systems may load all of the components on which a given component depends before they can validate the dependencies. Since a component may have dependencies on more components that are actually used in a given run of the component, allowing a component to run without having to load all of its dependencies saves computational resources that would be used to load the component. Moreover, if transmitting the unused components to the execution environment can be avoided, then allowing a component to run without all of its dependencies being loaded also saves transmission bandwidth.

In one example use of the subject matter described herein, an entity may provide a web-based application (e.g., a map application, a music application, a social utility application, etc.) that is deployed on a web server, and may wish to make the application's functionality extensible through the use of third-party plug-ins. (A plug-in is a component that is recognized by the execution engine to import or export contract(s).) That is, third parties (or even the provider of the application) may develop and deploy plug-ins to be used with the application. The application may use a client-side execution environment, such as the MICROSOFT SILVERLIGHT system, Java Runtime Environment (JRE), or some other type of client-side execution environment. Thus, the application operates by delivering executable components to be executed by the client-side execution environment. When a third-party developer wants to add functionality to the application, the developer may write and submit a plug-in. The plug-in may import functionality from other components (or may export functionality to other components), with the intent that the plug-in will interoperate with components that make up the application, or with other third-party plug-ins. If the plug-in is approved to be deployed with the application, then its dependencies on other components are calculated and validated, and a catalog is created that describes the dependencies of the various components—including those of the new plug-in. When clients access the application, the catalog is provided to the clients, which relies on the catalog in determining valid dependencies, instead of validating the dependencies itself.

Components (including plug-ins) specify their dependencies on other components using the notion of a contract. In general, a contract represents some type of functionality (e.g., in the form of a string) that a component can import or export. In common parlance, the terms “import” and “export” are associated with the movement of data—e.g., “to import data” or “to export data.” However, with regard to contracts, to say that a component imports a contract means that the contract represents some functionality to be provided, and that the importing component consumes this functionality. Conversely, to say that a component exports a contract means that the component provides the functionality specified by the contract, so that this functionality can be consumed by other components. Thus, a component that imports functionality includes an “import” statement that includes the string that represents the contract to be imported. And, a component that exports functionality includes an “export” statement that identifies the contract for which the component provides functionality. The process of pre-calculating dependencies includes determining which pairs of components are importers and exporters of the same contract, and thus which components are to be connected together at runtime. The pre-calculation process may also include performing type checking on these pairs of components (since two components may name the same contract, but there may be a type mismatch between their implementations). The pre-calculation process may also determine whether there are any access restrictions on components—i.e., whether some components specify that they are not permitted to interoperate with other components. The pre-calculated dependencies are then stored in a catalog, which may be provided to the client that provides the environment under which the components execute.

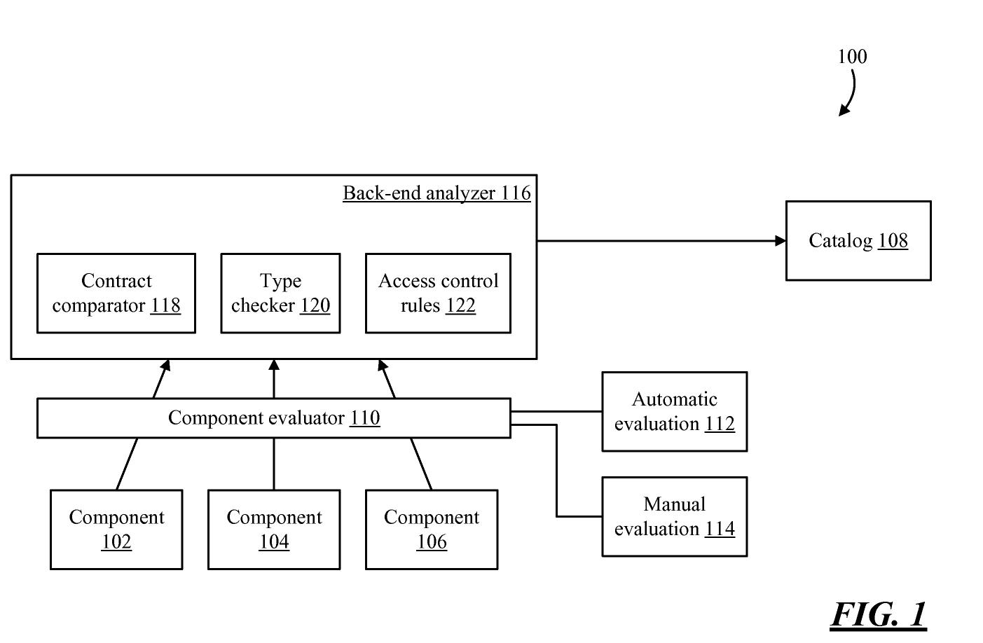

Turning now to the drawings, FIG. 1 shows an example system 100 in which components may be analyzed to determine and validate dependencies. System 100 receives one or more components, such as components 102, 104, and 106, and produces a catalog 108 that indicates how the components are to be connected when they operate together.

Components 102-106 may be received from any type of provider. For example, components 102-106 may be plug-ins for a web-based application, and the plug-ins might be provided by third-party software developers. (While the term “plug-in” is often associated with extension modules for Netscape/Mozilla browsers, the term “plug-in,” as used herein, is not so limited. In general, a plug-in may be any kind of software component that provides and/or extends functionality on an existing application and/or platform. In this sense, ActiveX controls, or modules for use with the MICROSOFT SILVERLIGHT system, etc., are examples of plug-ins.) As one example, an on-line map service is an example of a web-based application. The basic on-line map service might provide the functionality to display maps and satellite or aerial images of geographic locations. However, more specific functions—e.g., finding highly-rated restaurants in an area, showing user-supplied photos of an area, etc.—might be implemented through plug-ins. The plug-ins that implement these features are examples of components 102-106. When catalog 108 is created, it may provide information about which components may work together, and which components depend on other components. It is noted that some of the components that appear in catalog 108 may be plug-ins that are provided by third-party software developers, but some of the components may be provided by the operators and/or implementers of the underlying application with which the third-party plug-ins are intended to work. For example, if the underlying application is an on-line map service, the provider of the service may provide components that allow third-party applications to access map images or other data, so that the plug-in components can use these images or data.

When components 102-106 are provided to system 100, they may be evaluated by a component evaluator 110 to make an initial determination of their fitness to be used. Component evaluator 110 may implement various processes of automatic evaluation 112 and/or manual evaluation 114. Examples of automatic evaluation 112 may include tests for robustness (e.g., resistance to crashes), tests for the presence of viruses or other malware, or other types of tests. Manual evaluation 114 may include analyses performed by a person. For example, the application or other platform with which a component is intended to work may have substantive standards about what types of components are appropriate. Thus, before accepting a component to be used as a plug-in, the operator may have a programmer read the code to determine whether the code meets the operator's technical and/or content standards. For example, a program that is technically robust and contains no malware might pass automatic evaluation 112, but such a component might contain offensive content that the operator of the underlying platform or application deems substantively inappropriate. Thus, such a component could be rejected based on manual evaluation 114 even if it passes automatic evaluation 112. Component evaluator 110's use of automatic and manual evaluation processes is merely an example. The subject matter herein applies to systems that use any type of evaluation process to accept or reject components, and also applies to systems that perform no such evaluation (e.g., systems that accept all components that are offered).

When a component has been accepted for use, it may be analyzed by back-end analyzer 116. Back-end analyzer 116 identifies dependencies among the components and evaluates the dependencies. Back-end analyzer 116 is “back-end” in the sense that it analyzes dependencies among components outside of the environment in which the components execute, in contrast to traditional DI systems where the validation of dependencies among components is performed at runtime by the components themselves.

Back-end analyzer 116 may include various types of components to perform analysis. The example of FIG. 1 shows back-end analyzer as using a contract comparator 118, a type checker 120, and a set of access control rules 122. The functions of these sub-components are discussed below. However, it is noted that these sub-components of back-end analyzer 116 represent an example set of functionalities, and an example division among those functionalities. Back-end analyzer could implement functionalities other than those shown in the example of FIG. 1, and could combine those functionalities into a single sub-component (or could separate the functionalities among a larger number of sub-components than is shown in FIG. 1).

In the example of FIG. 1, contract comparator 118 compares the contracts of different components to determine which components may function together as importer/exporter pairs. A contract is a specification of an abstract functionality that a component can implement or consume. In the examples mentioned above, specifying a shape is an example of such a functionality. The particular contract that a component implements or consumes may be described by a string. “Primary-shape” is an example of a string that may describe one type of shape functionality. “Secondary-shape” is an example of a string that may describe some other type of shape functionality. The importer and exporter typically achieve a common understanding as to what functionality is associated with a contract, and as to the nature of the interface that the importer and exporter will use to communicate with each other. For example, there might be a published specification that defines the “primary-shape” contract as performing the function of specifying a shape, and the specification might define a specific type of object that an exporter of that contract would expose. However, the subject matter herein is not limited to contracts that represent any particular type of functionality and/or interface, and are not limited to this example.

Thus, contract comparator 118 identifies components that import and export a particular contract. When a given contract is represented by a string, contract comparator 118 can identify importer/exporter pairs of components simply by looking for those components that specify the same contract string, and determining which one(s) of those components are importing the contract and which one(s) are exporting the contract.

Type checker 120 determines whether there are type mismatches in data that is being passed between parties to a contract. In a typical contract, the exporter component implements and some object that is part of the contract specification, and the importer uses that object. However, there could be a type mis-match between two components that purport to be importing or exporting the same contract. Type checker 120 analyzes components to determine whether there is a type mismatch in the way that an importer component is using an exporter component.

The providers of a given component may want to put limits on what other components the given component will work with. For example, a company that provides a component might want to allow a given component to work with other components written by the company or by the company's partners, but might want to prevent use by components from other companies. Thus, the provider of a component may specify a set of access rules 122. When back-end analyzer 116 produces catalog 108, catalog 108 may reflect these limitations on which components may interoperate with each other. For example, component A might export the contract “primary-shape” and components B and C might import the “primary-shape” contract. However, the provider of component A might want component A to be usable by component B but not by component C. This condition can be reflected in an access rule, and back-end analyzer may take this access rule into account when it constructs catalog 108. Catalog 108 may indicate, in some manner, that component A is to be used only with component B but not component C, so that when the plug-ins are connected by the DI system, the DI system can act accordingly.

Back-end analyzer 116 may take into account the information described above, and may produce catalog 108. Catalog 108 contains a description of what components exist, and what contracts they import and export. From the information in catalog 108, the environment in which the components are to be executed can determine how the various components are to be connected to each other.

The following is a specific example of how importer and exporter components may work together, and how the dependencies between these components may be pre-calculated and stored. Tables 1 and 2 below show example components that import and export a given set of contracts. Table 1 shows a component that imports the contracts named “Acme/PrimaryShape” and “Acme/SecondaryShape”. Table 2 shows a component that exports these contracts. The description that follows Tables 1 and 2 refers to these examples.

```
TABLE 1
class PlayTable : Plugin
{
  [ImportSingle(“Acme/PrimaryShape”, ImportLoadPolicy.Synchronous)]
  public Shape Shape1 { get; set; }
  [ImportSingle(“Acme/SecondaryShape”,
  ImportLoadPolicy.Synchronous)]
  public Shape Shape2 { get; set; }
  // Only valid after Initialize( ) called
  public double TotalVolume
  {
    get { return Shape1.Volume + Shape2.Volume; }
  }
}
```

TABLE 2

```
class ShapeProviders : Plugin
{
  private Shape _s1 = new Sphere( );
  private Shape _s2 = new Cube( );
  [ExportSingle(“Acme/PrimaryShape”)]
  public Shape AAA { get { return _s1; } }
  [ExportSingle(“Acme/SecondaryShape”)]
  public Shape BBB { get { return _s2; } }
}
```

The component in Table 1 is a class named “PlayTable.” The implementation of PlayTable in Table 1 wants to import objects, which are given the local names “Shape1” and “Shape2”. Both Shape1 and Shape2 are declared to be of the type “Shape”, but in seeking to import these objects, PlayTable defines Shape1 as being provided by the contract named “Acme/PrimaryShape”, and defines Shape2 as being provided by the contract “Acme/SecondaryShape.” PlayTable then returns the sum of Shape1.Volume and Shape2.Volume, so it is assumed that whatever objects are actually assigned to fulfill the roles of Shape1 and Shape2 will expose a function or data field called “Volume”.

The component shown in Table 2 exports two objects of type Shape, which are given the public names “AAA” and “BBB”. The component of Table 2, exports AAA to meet the “Acme/PrimaryShape” contract, and exports BBB to meet the “Acme/SecondaryShape” contract. This component assumes that there are concrete objects called “Cube( )” and “Sphere( )” are derived from the type Shape. The component assigns AAA and BBB to return instances of Cube( ) and Sphere( ), respectively. So, in effect, what the component of Table 2 does is to export Cube( ) (under the public name “AAA”) as an object that meets the contract “Acme/PrimaryShape”, and to export Sphere( ) (under the public name “BBB”) as an object that meets the contract “Acme/SecondaryShape”.

An execution environment that implements dependency injection may connect the components of Tables 1 and 2 so that the Table 1 component can use the objects exported by the Table 2 component. That is, a DI system can “wire” these components together so that Table 1's “Shape1” will call Cube( ), and Table 1's “Shape2” will call Sphere( ). Systems such as system 100 (shown in FIG. 1) may be used to determine, in advance of execution, that the Table 2 component can provide the Shape objects for the Table 1 component, so that this determination does not have to be made at runtime.

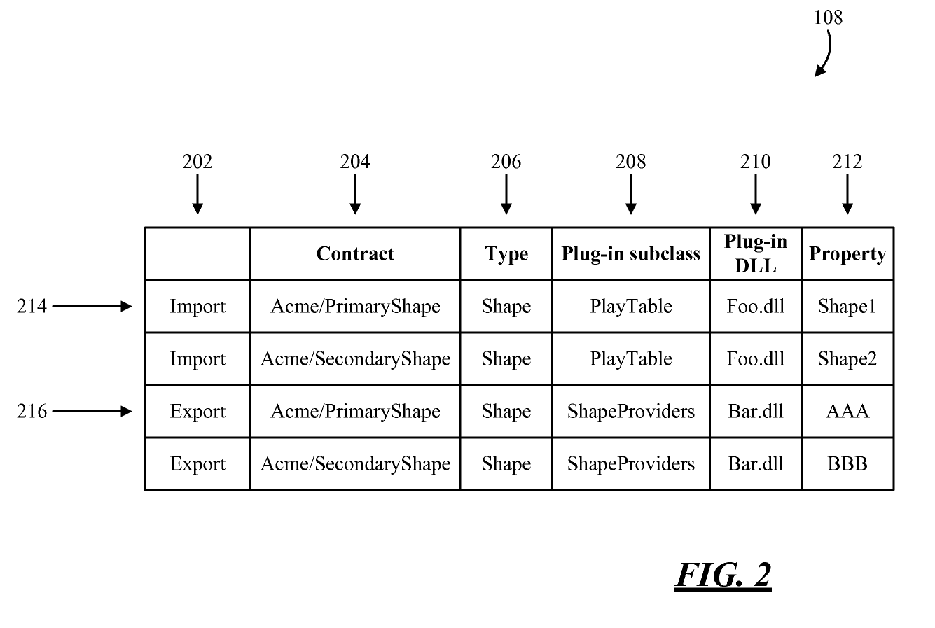

FIG. 2 shows an example of catalog 108. The example of FIG. 2 relates to the imports and exports in the components of Tables 1 and 2, and lists various information about these components. In the example of FIG. 2, each import or export made by a component has a row (or some other type of record) in catalog 108. Catalog 108 has various columns of information. Column 202 indicates whether a given row describes an import or an export. Column 204 indicates the contract for which the import or export is being made. Column 206 indicates the object type that is being imported or exported. Column 208 indicates the sub-class of the plug-in that is providing an export, or that is using an import. Column 210 identifies the file in which is stored the plug-in that is providing the export or using the import. (As described below, plug-ins may be stored in a Dynamic Link Library (DLL), and thus the files in column 210, in the example of FIG. 2, have “.dll” extensions.) Column 212 provides the public property name of the object instance that is being imported or exported.

With reference to the components shown in Tables 1 and 2, each import or export made in those components has a row in catalog 108. For example, row 214 relates to the import of an “Acme/PrimaryShape” contract made by the component of Table 1. As described above, that component defines an object named “PlayTable”. PlayTable defines an object of type “Shape” with the property name “Shape1”, and specifies that Shape1 is to be imported according to the contract “Acme/PrimaryShape.” Thus, in row 214, column 202 indicates that the row is to describe an import. Column 208 indicates the name of the plug-in (“PlayTable”) that is doing the importing. Column 204 specifies the contract name “Acme/PrimaryShape”; columns 206 and 212 indicate the type and name of the property, respectively. And column 210 indicates that the PlayTable plug-in is stored in a file named “foo.dll” (which may help the loader to find the file when the PlayTable plug-in is to be loaded during execution).

There is a similar row in catalog 108 for PlayTable's import of Shape2 under the contract “Acme/SecondaryShape”.

Exports also have rows in catalog 108. For example, row 216 describes an export made by the ShapeProviders plug-in under the contract “Acme/PrimaryShape.” Row 216 indicates that the ShapeProviders plug-in is stored in the file named “bar.dll”, and that it exports a property whose name is “AAA” and whose type is “Shape”, where the property is exported under the contract “Acme/PrimaryShape.” ShapeProviders make a similar export under the contract “Acme/SecondaryShape”, and catalog 108 contains a similar row to describe that export. It is noted that, the existence in catalog 108 of both export and import entries for the same contract is an example way of indicating that two components are to be connected at runtime. However, an indication that two components are to be connected at runtime could be made in catalog 108 in any appropriate manner.

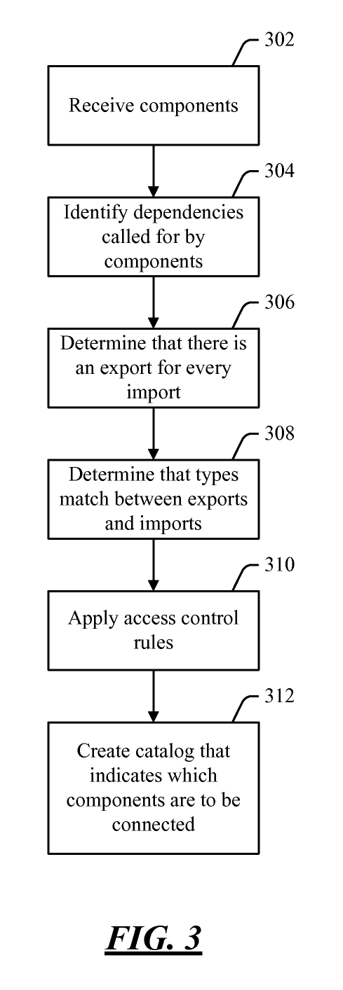

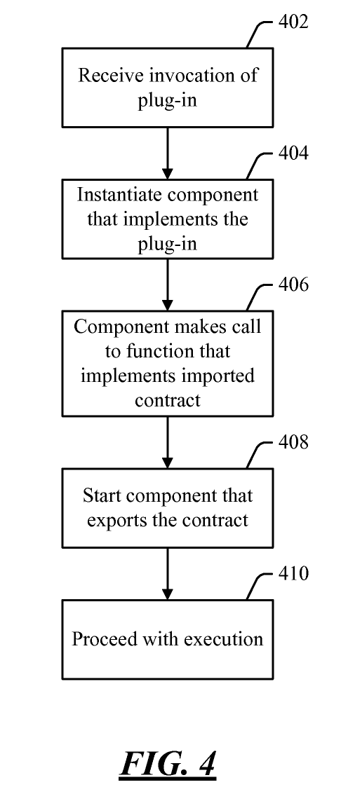

FIG. 3 shows an example process that may be performed to evaluate components for dependencies. Before turning to a description of FIG. 3, it is noted that each of the flow diagrams contained herein (both in FIG. 3 and in FIG. 4) shows an example in which stages of a process are carried out in a particular order, as indicated by the lines connecting the blocks, but the various stages shown in these diagrams can be performed in any order, or in any combination or sub-combination.

At 302, executable components (e.g., plug-ins) may be received. At 304, dependencies called for by the components are identified. For example, if a component imports functionality according to a particular contract, then the contract is a dependency of the component, and the existence of this dependency is identified at 304.

At 306, it is determined whether an export exists for every import. Since DI allows an importing component to bind the imported functionality to a contract instead of a specific object, in order to allow the importing component to use the sought functionality the DI system has to make sure that some component is exporting the contract that the importing component seeks to import. Thus, the process of FIG. 3 may check that, for every contract sought to be imported by a component, there is some other component that exports that same contract. A component that exports a contract can be used by more than one component that seeks to import that contract. However, if there is more than one component that exports the same contract, then the process of FIG. 3 may choose one of the exporting components to match with the importing component. Or, the choice of a particular exporting component may be made by an external source—e.g., by the operator of the application or platform with which the components will be used.

At 308, a determination is made as to whether there is a type match (or mis-match) between imports and exports. Even if a pair of importing/exporting component match due to naming the same contract, it is possible that there may be a type mismatch between these components. E.g., one component may attempt to import a particular type of object under a given contract, and another component may attempt to export a different type of object under the same contract. Thus, at 308, it is determined that a pair of components match not only on the basis of the contract that they are importing/exporting, but also based on consistency between the object types or data types that are being imported/exported.

At 310, access control rules may be applied to the components. As noted above, a component may import or export a particular contract, but the author of that component may want to limit the set of other components with which the author's component can interoperate. For example, component A might export the “Acme/PrimaryShape” contract, which is imported by components B and C. However, the author of component A might want to allow only B to use A. In this case, the process of FIG. 3 may restrict C from using A, even though C and A have the same contract in common. When the catalog is generated, the catalog may reflect this restriction so that the environment in which A, B, and C are to be executed can allow B to use A while disallowing C from using A.

At 312, a catalog may be generated. Example contents of a catalog are shown in FIG. 2 and are discussed above. In particular, the catalog may indicate which contracts particular components import and export, what file the component is located in, or any other appropriate information. Additionally, if there are access restrictions on a component, the catalog may reflect these access restrictions by indicating which pairs of components are (or are not) to be used together. At some point after the catalog has been created, it may be sent to the machine on which the components will execute.

FIG. 4 shows an example process in which a plug-in may be invoked, and in which pre-calculated dependencies may be injected into the plug-in. In one example, a server (e.g., a web server) provides code to be executed in an environment that is present on a client. For example, the client may have the MICROSOFT SILVERLIGHT system (which is an example of a platform that can host an execution environment), and the server may deliver, to the client, components that are to be executed by the MICROSOFT SILVERLIGHT system. Some of these components may implement a base application (e.g., a map application), and other components may be plug-ins that are designed to work with the base application.

At 402, an invocation of the plug-in is received. For example, a user may be using the map application, and, through the user interface, may request to use some functionality that is implemented through a particular plug-in. At 404, the component that implements the plug-in may be instantiated in response to the invocation. Since the user might, or might not, use a given plug-in, downloading of the plug-ins to the client may be withheld until the user actually invokes the plug-in, thereby conserving transmission bandwidth in those situations where a given plug-in is not actually used. Thus, when the user invokes the plug-in, the file that contains the plug-in may be downloaded if the plug-in is not already present on the client.

At 406, the component that implements the plug-in makes a call to some function that is to be imported under a contract. The execution environment looks up the component that will export the given contract for the calling component, and starts that component (at 408). There may be many components, and, in a typical usage, it may be the case that only a handful of these components will actually be used. For example, a plug-in might import many different functionalities, but an actual use of the component may use only a few of these functionalities during the course of the plug-in's execution. Thus, it is possible that the file containing the exporting component has not been downloaded to the client (in order to conserve transmission bandwidth). If the plug-in is not available on the client, it may be downloaded from the server so that it can be used by the plug-in. It is noted that, in traditional dependency injection systems, the exporters of all contracts that a component can use typically have to be loaded and running before the importing component can run, since the importing component has to validate all of its dependencies. By pre-calculating dependencies and allowing a component to run on the basis of the pre-calculated dependencies, it is possible to run a plug-in without running all of the components on which the plug-in depends, since the components that export functionality to the plug-in can be loaded later if the plug-in actually makes use of their functionality. The circumstance in which a component is allowed to run, even when its dependencies have not been loaded, may be referred to as asynchronous contract loading.

After the components that export the requested functionality to the plug-in have been loaded, the plug-in's execution may proceed (at 410).

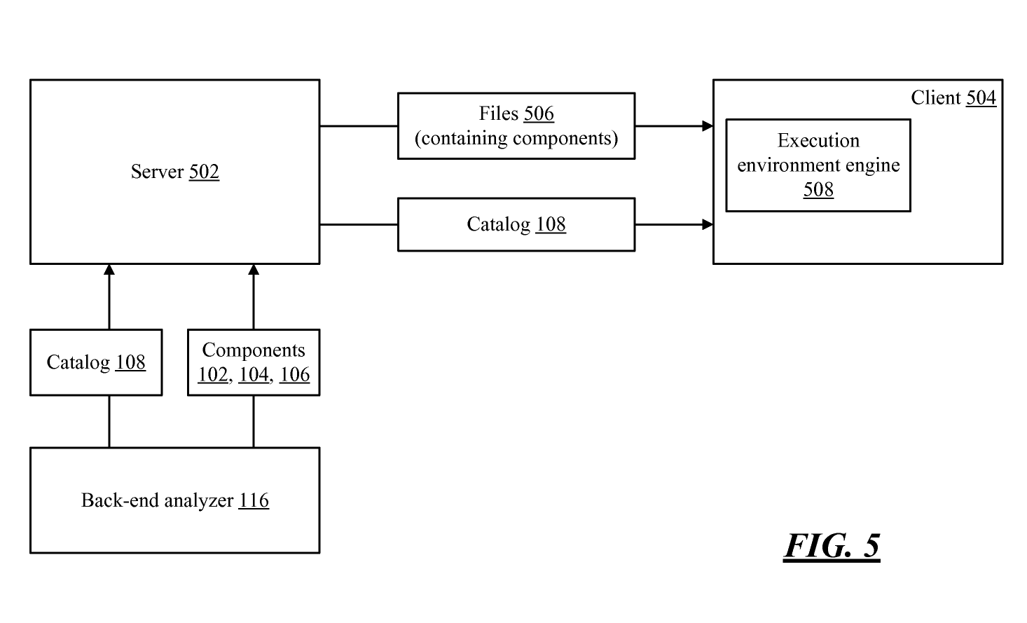

FIG. 5 shows an example scenario in which dependencies between components may be pre-calculated, and in which the components and pre-calculated dependencies may be used on a client. The environment shown in FIG. 5 includes a server 502 and a client 504. Server 502 provides software to be executed on client 504. For example, server 502 may be a web server that implements a particular web application (e.g., a map application, a music application, a social utility application, etc.). Server 502 may receive components (such as components 102, 104, and 106) and catalog 108 from back-end analyzer 116. (Components 102-106, catalog 108, and back-end analyzer 116 are described above in connection with FIG. 1).

Client 504 may initiate contact with server 502 in order to use the application that server 502 provides. For example, a user of client 504 may use a web browser to contact server 502, and server 502 may respond by providing executable components and other content to client 504. For example, server 502 may provide one or more files 506 which contain executable components (such as executable components 102-106), and server 502 may also provide a copy of catalog 108 to client 504. The files containing the executable components may take any form. In one example form, files 506 are compressed files (e.g., zip files) that contain one or more Dynamic Link Library (DLL) files, where each DLL contains one or more executable components. (A DLL can contain multiple executable components. Moreover, while DLLs are normally used to store components that execute natively on a particular machine (e.g., x86 machine code), a DLL can also contain intermediate code that runs on a virtual machine or other type of execution platform.)

Client 504 may have an engine 508 that implements an execution environment. The MICROSOFT SILVERLIGHT system is an example of an engine that implements an execution environment, although other types of engines (e.g., Java Runtime Environment) could be used. The components that are delivered to client 504 are able to run on an execution environment engine(s) that is available on (or that can be installed on) client 504.

Engine 508 runs executable components that have been delivered to client 504. At some point during the use of these executable components, some functionality implemented by a plug-in may be invoked. For example, a user may request to invoke some functionality that is implemented by a plug-in. If the plug-in is not already available on client 504, then the file containing the plug-in may be downloaded. When the plug-in is loaded into the execution environment, engine 508 may verify (using catalog 108) that the plug-in's dependencies have been validated, and then may run the plug-in. As noted above, in some cases the plug-in may not use all of its dependencies, and thus loading of the dependencies may be deferred until the functionality of these dependencies is actually used by the plug-in (which, as described above, may be referred to as asynchronous contract loading).

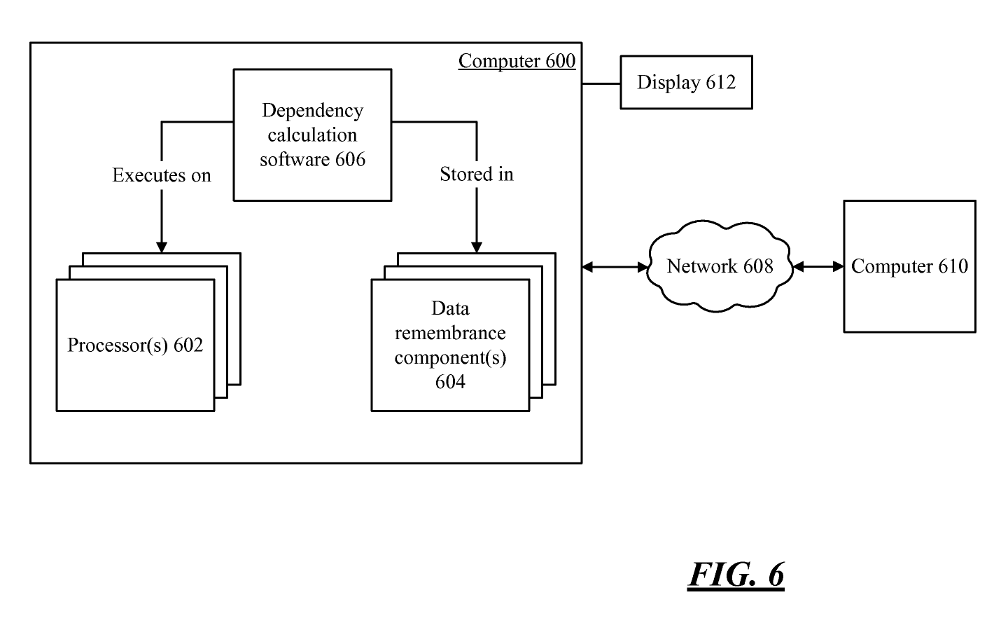

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is dependency calculation software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through communication network 608. Computer 610, which may be similar in structure to computer 600, is an example of a device that can be connected to computer 600, although other types of devices may also be so connected. Each of computers 600 and 610 may have a communication mechanism (e.g., a network interface, etc.) that allows communication to occur between these two computers using network 608.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of supporting interaction between software components, the method comprising:
using a processor to perform acts comprising:
receiving a first component;
identifying, in said first component, a contract to be imported into said first component from outside of said first component;
determining that a second component exists that exports said contract;
creating a catalog that comprises an indication that, to provide functionality under said contract to said first component, said second component is to be connected to said first component;
receiving, from a client, a request to invoke an application that comprises said first component; and
transmitting, to said client, said first component and said catalog.

2. The method of claim 1, wherein said catalog comprises:
data that identifies said first component as an importer of said contract; and
data that identifies said second component as an exporter of said contract.

3. The method of claim 1, wherein said acts further comprise:
determining there is not a type mismatch between said first component and said second component.

4. The method of claim 1, wherein said acts further comprise:
determining, based on an access control rule, that said second component is allowed to be used by said first component.

5. The method of claim 1, wherein said acts further comprise:
including said first component in a Dynamic Link Library (DLL) file that includes one or more other components;
wherein said transmitting of said first component comprises transmitting said DLL file to said client.

6. The method of claim 5, wherein said acts further comprise:
creating a compressed file that comprises said DLL file and one or more other DLL files;
wherein said transmitting of said DLL file comprises transmitting said compressed file to said client.

7. The method of claim 1, wherein said contract is identified by a string, wherein said first component comprises an import instruction that includes said string, and wherein said second component comprises an export instruction that includes said string.

8. The method of claim 1, wherein said first component comprises a first property name that is associated with a first object to be imported under said contract, wherein said second component comprises a second property name that is associated with a second object to be exported under said contract, and wherein said catalog lists said first property name with a record of said first object and lists said second property name with a record of said second object.

9. The method of claim 8, wherein said first object is of a type, wherein said second object is of said type, and wherein said catalog lists said type in said catalog's records of said first object and said second object.

10. The method of claim 1, wherein said first component comprises a plug-in for a web application, and wherein said client requests to use said web application.

11. The method of claim 10, wherein said web application is provided by a first party, and wherein said receiving of said first component comprises:
receiving said first component from a second party that is different from said first party.

12. One or more computer-readable storage media that store executable instructions to allow components to interoperate, wherein said instructions, when executed on a computer, cause the computer to perform acts comprising:
receiving, from a machine through a communication network, a catalog that comprises an indication that: (a) a first component imports a contract, and (b) a second component exports said contract;
receiving, from said machine through said communication network, a first file that comprises said first component;
loading said first component into an execution environment;
determining, based on said catalog, that said first component is dependent on said second component;
receiving a request for action that is to be performed by said first component but that does not use functionality that said first component imports from said second component under said contract; and
allowing said first component to execute without said second component being loaded into said execution environment.

13. The one or more computer-readable storage media of claim 12, wherein said first file is a Dynamic Link Library (DLL) file that comprises said first component and one or more other components.

14. The one or more computer-readable storage media of claim 13, wherein first file is a compressed file that comprises said DLL file and one or more other DLL files.

15. The one or more computer-readable storage media of claim 12, wherein said acts further comprise:
determining that a set of access control rules permit said second component to be used with said first component.

16. The one or more computer-readable storage media of claim 12, wherein said execution environment allows said first component to execute when said second component is not present on a machine at which said execution environment operates.

17. The one or more computer-readable storage media of claim 12, wherein said acts further comprise:
making a request, to a server, to operate an application that is provided by said server;
wherein said request is made by a client to a server, wherein said server provides an application that executes on said client, and wherein said first component is a plug-in for said application.

18. A system for controlling interoperation among executable components, the system comprising:
a processor;
a data remembrance component;
a dependency calculation component that executes on said processor and that is stored in said data remembrance component, the system receiving a first component that specifies a contract to be imported and a second component that specifies that said second component exports said contract, the dependency calculation component determining, based on an access rule, that said second component is not be used with said first component, said dependency calculation component generating a catalog that identifies said first component as an importer of said contract and that further identifies said second component as an exporter of said contract, said catalog indicating that said second component is not to be used to export said contract to said first component; and
a communications mechanism through which said first component and said catalog are communicated to a client that provides an execution environment on which said first component and said second component execute.

19. The system of claim 18, wherein said first component is sent to said client in a Dynamic Link Library (DLL) file that includes one or more other components that are in an intermediate language that is executable on a virtual machine provided by said execution environment.

20. The system of claim 18, wherein said dependency calculation component identifies a third component that export said contract and includes, in said catalog, an indication that said third component is to be used to provided, to said first component, functionality associated with said contract.
